(19) United States
(12) Patent Application Publication
(10) Pub. No.: US 2015/0117288 A1
(43) Pub. Date: Apr. 30, 2015

(54) METHOD AND DEVICE FOR TETHERING

(71) Applicant: Samsung Electronics Co., Ltd., Gyeonggi-do (KR)

(72) Inventor: Youn Ho PARK, Gyeonggi-do (KR)

(73) Assignee: Samsung Electronics Co., Ltd.

(21) Appl. No.: 14/488,825

(22) Filed: Sep. 17, 2014

(30) Foreign Application Priority Data
Oct. 31, 2013 (KR) 10-2013-0130910

(51) Int. Cl. H04W 52/02; H04W 72/04

(52) U.S. Cl. CPC H04W 52/0206; H04W 72/042; H04W 88/08
USPC 370/311

(57) ABSTRACT

A device for tethering is provided, which includes a storage unit configured to store commands for a tethering operation, and a control unit configured to perform the commands stored in the storage unit, to determines whether a preset condition is satisfied while providing tethering to at least one target terminal, and to adjust a transmission period of a beacon message transmitted at a certain period for the tethering if the preset condition is satisfied.

### PRIORITY

This application claims priority under 35 U.S.C. §119(e) to Korean Patent Application No. 10-2013-0130910 filed in the Korean Intellectual Property Office on Oct. 31, 2013, the content of which is incorporated herein by reference.

### BACKGROUND OF THE INVENTION

1. Field of the Invention

The present invention generally relates to a method and a device for tethering.

2. Description of the Related Art

Tethering refers to providing services, related to external mobile communication networks accessed by electronic devices, to peripheral devices such as Information Technology (IT) devices including notebooks, netbooks, tablet Personal Computers (PCs), desktop PCs, E-book readers and Personal Digital Assistants (PDAs) that are connected to the electronic devices through USB ports, Bluetooth devices, or Wi-Fi. The electronic devices may function as wireless Internet access points (APs), and each peripheral device may use wireless Internet services through the electronic devices without modules that may access mobile communication networks. Since electronic devices that provide tethering operate in the same manner as wireless Local Area Network (LAN) APs, they need to periodically inform peripheral devices of their presence and locations in order to maintain a tethering access. Thus, the electronic devices periodically create and transmit beacon messages.

However, since typical electronic devices need to continue to transmit beacon messages while providing tethering, and the beacon messages are transmitted at short time intervals, for example, every 100 milliseconds (ms), the power consumption of the electronic devices may increase due to frequent beacon message transmission.

### SUMMARY OF THE INVENTION

The present invention has been made to solve at least the above-mentioned problems and/or disadvantages and to provide at least the advantages described below. Accordingly, an aspect of the present invention provides a method and device for tethering that may adjust the transmission period of a beacon message when a specific condition is satisfied while a user device provides tethering.

According to an aspect of the present invention, a device for tethering is provided, which includes a storage unit configured to store commands for a tethering operation; and a control unit configured to perform the commands stored in the storage unit, to determine whether a preset condition is satisfied while providing tethering to at least one target terminal, and to adjust a transmission period of a beacon message transmitted at a certain period for the tethering when the preset condition is satisfied.

According to another aspect of the present invention, a method for tethering is provided, which includes determining whether a preset condition is satisfied while providing tethering to at least one target terminal; and adjusting a transmission period of a beacon message transmitted at a certain period depending on whether the preset condition is satisfied.

According to another aspect of the present invention, a system is provided, which includes at least one target terminal; and a user device configured to be connected to the at least one target terminal by using a local area communication technique and to provide tethering related to a communication channel formed with an external communication network to the at least one target terminal. The user device adjusts a transmission period of a beacon message transmitted for the tethering depending on whether a preset condition is satisfied while providing the tethering to the at least one target terminal.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a diagram illustrating a system, according to an embodiment of the present invention;

FIG. 2 is a diagram illustrating a configuration of a tethering device, according to an embodiment of the present invention;

FIG. 3 is a flowchart illustrating a method of providing tethering in a tethering device, according to an embodiment of the present invention;

FIG. 4 is a flowchart illustrating a method of adjusting the transmission period of a beacon message in a tethering device, according to an embodiment of the present invention;

FIG. 5 is a flowchart illustrating a method of recognizing an operation condition in a tethering device, according to an embodiment of the present invention;

FIG. 6 is a flowchart illustrating a method of recognizing a button manipulation condition in a tethering device, according to an embodiment of the present invention;

FIG. 7 is a flowchart illustrating a method of recognizing a condition according to the number of access terminals, according to an embodiment of the present invention;

FIG. 8 is a flowchart illustrating a method of initializing the transmission period of a beacon message in a tethering device, according to an embodiment of the present invention;

FIG. 9 is illustrated for explaining an operation of recognizing an operation in a tethering device according to an embodiment of the present invention;

FIG. 10 illustrates recognition of a button manipulation in a tethering device, according to an embodiment of the present invention; and

FIG. 11 illustrates recognition of a button manipulation in a tethering device, according to another embodiment of the present invention.

### DETAILED DESCRIPTION OF EMBODIMENTS OF THE PRESENT INVENTION

The present invention is described below in detail with reference to the accompanying drawings. In this case, it should be noted that the same components may be represented by the same reference numerals in the drawings. Also, a detailed description of known functions and/or configurations is not provided. In the following, parts needed for understanding operations according to various embodiments are mainly described and elements that may make the subject matter obscure are not described.

Also, some components in the drawings may be exaggerated, omitted or schematically shown. The size of each component does not accurately reflect the actual size, and thus, the descriptions made herein are not limited by the relative sizes or spaces between components shown in the drawings.

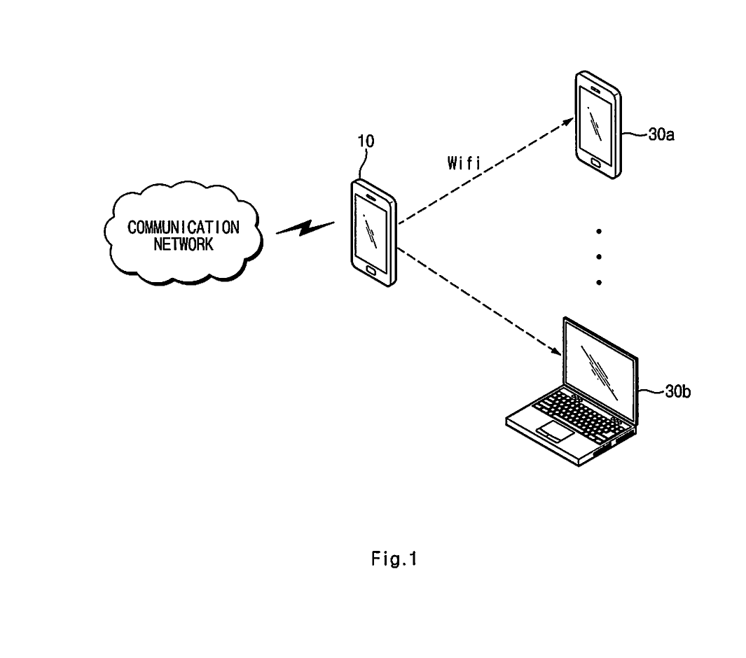

FIG. 1 is a diagram of a system according to an embodiment of the present invention.

Referring to FIG. 1, a system according to an embodiment of the present invention includes a tethering device 10 and at least one of target terminals 30a and 30b.

The tethering device 10 is a user device that provides tethering, and the target terminals 30a and 30b are terminals that use tethering provided from the tethering device 10. In this example, the tethering device 10 is a user device that includes a communication module supporting a communication interface capable of accessing a mobile communication network such as a third generation (3G), fourth generation (4G), or 4G Long Term Evolution (LTE) communication network, and a wireless Local Area Network (LAN) module supporting short range communication.

On the other hand, the target terminals 30a and 30b are terminals that include wireless LAN modules supporting local area communication with the tethering device 10. Since the target terminals 30a and 30b use communication channels that are formed between the tethering device 10 and communication networks through a tethering access by the tethering device 10, they may not have separate communication modules supporting communication with mobile communication networks.

For example, the target terminals 30a and 30b may be wireless terminals, such as note books, net books, tablet Personal Computers (PCs), desktop PCs, E-book readers, and Personal Digital Assistants (PDAs).

The tethering device 10 provides tethering to the target terminals 30a and 30b through local area communication with at least one target terminal 30a and 30b, for example, through a Wi-Fi access. The tethering device 10 adjusts the transmission period of a beacon message transmitted to maintain tethering access depending on whether a preset condition is satisfied while tethering is provided to the target terminals 30a and 30b.

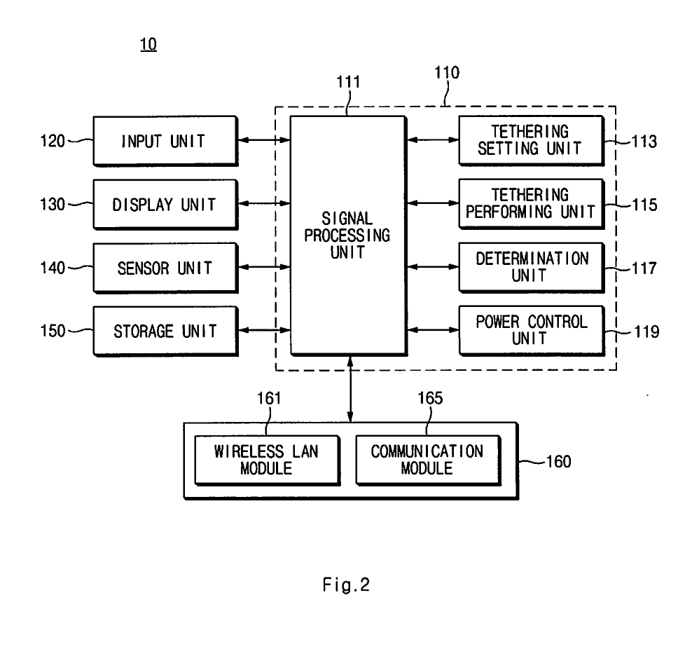

The detailed configurations of the tethering device 10 are described in more detail with reference to FIG. 2.

FIG. 2 is a diagram of a configuration of a tethering device according to an embodiment of the present invention.

Referring to FIG. 2, the hardware components of the tethering device 10 include a control unit 110, an input unit 120, a display unit 130, a sensor unit 140, a storage unit 150, and a communication unit 160.

The input unit 120 is a device for receiving a certain signal from a user. The input unit 120 may be a keypad that includes a plurality of key buttons. The input unit 120 may also be a touch screen that may implement soft keys on a screen. The input unit 120 may be a device that may input a signal to the tethering device 10 by a user manipulation, such as through a joystick or a wheel. The input unit 120 may be implemented as function keys or soft keys that are selected to operate a tethering mode of the tethering device.

The display unit 130 is used to display an execution screen that is provided as a result of operating the tethering device 10. The display unit 130 may be implemented as a type of Liquid Crystal Display (LCD), Organic Light-Emitting Diode (OLED), or active OLED, or may be implemented as a touch screen type supporting a touch-based input.

The display unit 130 may display a screen for configuring a tethering mode. The display unit 130 may display a screen capable of being implemented while the tethering device 10 operates in the tethering mode. For example, the screen is a tethering access screen. In this case, the tethering access screen displayed through the display unit 130 is a screen showing a tethering access state in the tethering mode and may include a power-saving button according to the configuration of the tethering mode. The display unit 130 may include a button or a menu for changing or negating the configuration of the tethering mode. For example, the power-saving button may be implemented as a soft key type or a scroll bar type.

The sensor unit 140 senses the movement of the tethering device. The sensor unit 140 may be at least one of a gyro sensor outputting an electrical signal according to the location change of three axes from the movement of the tethering device, an acceleration sensor outputting an electrical signal according to the acceleration of three axes generated from the movement of the tethering device, and a proximity sensor detecting whether the tethering device comes close to other objects. In addition to the above-described sensors, the sensor unit 140 may be any sensor that may sense the movement of the tethering device, such as a vibration sensor and an illumination sensor.

When the tethering device 10 operates in the tethering mode, the sensor unit 140 may detect a movement of the tethering device 10 from each sensor. In this case, the sensor unit 140 may provide detected movement information to a determination unit 117 to determine whether an operation condition for adjusting the transmission period of a beacon message is satisfied.

The storage unit 150 stores settings for the operation of the tethering device 10. The storage unit 150 may store programs and applications for implementing the operation of the tethering device 10. The storage unit 150 may store configuration settings for a tethering mode operation. For example, the storage unit 150 may store information on specific conditions set to adjust the transmission period of a beacon message in the tethering mode, namely, an operation condition on a specific motion, a power-saving button manipulation condition, and an access condition related to a preset number of target terminals. In this example, the storage unit 150 may also store a pre-registered white list which is a reverse of black list and a list of allowed objects. The types of the above-described specific conditions are just examples and are not limited thereto.

The storage unit 150 may also store information on the transmission period of a beacon message when operating in the tethering mode, and information used for adjusting the transmission period of the beacon message. The storage unit 150 may store information generated when performing tethering between the tethering device 10 and target terminals, for example, Media Access Control (MAC) addresses, terminal identification information and Service Set IDentifiers (SSIDs).

The communication unit 160 supports a wireless communication interface for the tethering device 10. In this example, the communication unit 160 may include a wireless LAN module 161 supporting local area communication with at least one target terminal and a communication module 165 forming a communication channel with a communication network. The wireless LAN module 161 may support various types of local area communication. Hereinafter, Wi-Fi is described as an example of the wireless LAN module 161, but is not limited thereto.

When the tethering device 10 operates in the tethering mode while a communication channel is formed with a communication network by the communication module 165, the wireless LAN module 161 provides, to a Wi-Fi accessed target terminal, tethering related to the communication channel formed by the communication module 165. The wireless LAN module 161 may transmit a beacon message for an access to the target terminal. If the wireless LAN module 161 is tethering-accessed the target terminal, it may maintain the tethering access to the target terminal or transmit a beacon message for an access to another target terminal at a certain period.

The control unit 110 includes a signal processing unit 111, a tethering setting unit 113, a tethering performing unit 115, a determination unit 117, and a power control unit 119. The signal processing unit 111 processes signals that are delivered between units in the control unit 110.

The tethering setting unit 113 performs configuring for a tethering mode operation. The tethering setting unit 113 may set the maximum number of terminals capable of being tethering-accessed, the initial transmission period of a beacon message, a specific condition for adjusting the transmission period of the beacon message, and the change transmission period of the beacon message. For example, the tethering setting unit 113 may set the maximum number of terminals capable of being tethering-accessed to 10, the initial transmission period of the beacon message to 100 milliseconds (ms), and the change transmission period of the beacon message to 1 second (s). The values above are just examples and are not limited thereto.

The tethering setting unit 113 may set the specific condition according to a manual or automatic switching mode when setting the specific condition for adjusting the transmission period of the beacon message. In other words, the tethering setting unit 113 may manually set an operation condition for adjusting the transmission period of the beacon message and/or a power-saving button manipulation condition.

The tethering setting unit 113 may automatically set a condition for adjusting the transmission period of the beacon message. For example, the tethering setting unit 113 may set the number of access terminals, namely, a critical value for adjusting the transmission period of the beacon message. In this example, when the transmission period of the beacon message is adjusted on the condition that the number of target terminals providing tethering is two, the critical value may be set to 2.

As another example, the tethering setting unit 113 may limit target terminals to be counted as access terminals for adjusting the transmission period of the beacon message to terminals on a white list. In this example, the tethering setting unit 113 may set the critical value to a specific number such that when the transmission period of the beacon message is adjusted on the condition, at least one of target terminals on the white list is accessed.

The tethering setting unit 113 may set a condition to perform a power-saving function of the tethering device 10, if a preset specific condition is satisfied while tethering is provided to a target terminal. For example, the tethering setting unit 113 may set a condition to adjust the transmission period of the beacon message when the power-saving function of the tethering device 10 is performed.

In response to a request from at least one target terminal Wi-Fi accessed through a wireless LAN module in a condition set by the tethering setting unit 113 when the tethering device 10 operates in the tethering mode, the tethering performing unit 115 may provide tethering to that target terminal. For example, the tethering performing unit 115 may create a beacon message for a tethering access and transmit the beacon message through the wireless LAN module. In this case, in response to a beacon message, tethering is provided to the target terminal that has made a request for the tethering access.

The tethering performing unit 115 may create a beacon message for maintaining the tethering access while providing tethering to at least one target terminal, and transmit the beacon message through the wireless LAN module. In this case, the tethering performing unit 115 may repetitively transmit the beacon message according to a preset transmission period while providing tethering to the at least one target terminal. The tethering performing unit 115 may transmit the beacon message at a first period that is initially set, or transmit the beacon message at a second period according to the control of the power control unit 119. The beacon message may include at least one of the MAC addresses of the tethering device 10, terminal identification information, and an SSID.

The determination unit 117 determines whether a preset specific condition is satisfied while the tethering device 10 provides tethering to at least one target terminal. The preset specific condition may be satisfied when a movement to a specific direction of the tethering device 10 is recognized, when a user input associated with a specific button of the tethering device 10 is recognized, or when the number of target terminals is greater than or equal to a specific value.

For example, when an operation condition for manually adjusting the transmission period of the beacon message is set, the determination unit 117 may determine whether a preset operation condition is satisfied, based on a movement recognized from a sensor value input through the sensor unit 140. The operation condition may include an operation of reversing the tethering device, an operation of moving in at least one of upward, downward, leftward and rightward directions, an operation of rotating about a specific direction, and an operation of dragging the screen of the tethering device 10 to a specific direction. In addition, any operations capable of being manipulated by a user may be applied.

When a condition for manually adjusting the transmission period of a beacon message through a button is set, the determination unit 117 may determine whether a preset button manipulation condition is satisfied, based on whether a button (for example, a power-saving button) is manipulated, while tethering is provided to at least one target terminal. The power-saving button may be one implemented on a tethering access screen or may be a key button placed on a key pad. The power-saving button implemented on the tethering access screen may be implemented as a soft key type or scroll bar type button.

When the operation condition for manually adjusting the transmission period of the beacon message and the button manipulation condition are set, the determination unit 117 may determine whether a preset operation condition and/or button manipulation condition is satisfied, based on at least one of a movement recognized from a sensor value input through the sensor unit 140 and a button manipulation.

As another example, when a critical value is set for the number of target terminals to which tethering is provided for the automatic adjustment of the transmission period of a beacon message, the determination unit 117 may count the number of target terminals to which tethering is provided, and determine whether a preset target terminal access condition is satisfied, based on the number of the counted target terminals.

When the terminals to be counted as access terminals are limited to the terminals on a white list, the determination unit 117 may determine whether a preset target terminal access condition is satisfied, based on the number of terminals in a pre-registered white list among target terminals to which tethering is provided.

If the power control unit 119 is informed from the determination unit 117 that a preset specific condition is satisfied while providing tethering to a target terminal by the tethering performing unit 115, the power control unit 119 may increase the transmission period of a beacon message transmitted at a certain period while providing tethering to the target terminal. For example, when the initially set transmission period of the beacon message is set to a first period (about 100 ms) and the transmission period when performing a power-saving function is set to a second period (about 1 s), the power control unit 119 may increase the transmission period of the beacon message if the preset specific condition is satisfied. In this case, the value of the second period may be set to be longer than that of the first period, and the transmission period may be adjusted from the first period to the second period.

As another example, the power control unit 119 may decrease the power consumption of the tethering device 10 if the preset specific condition is satisfied while providing tethering to a target terminal. In this example, the power control unit 119 may perform a power-saving function and adjust the transmission period of the beacon message from the first period to the second period if the power-saving function of the tethering device 10 is performed.

The power control unit 119 may not perform the power-saving function if a tethering access to at least one target terminal is released while the power-saving function is performed. In this case, the power control unit 119 may change the transmission period of the beacon message to the original state. That is, the transmission period of the beacon message may be initialized. In other words, the power control unit 119 may adjust the transmission period of the beacon message, which is adjusted from the first period to the second period due to the fulfillment of the power-saving function, back to the first period.

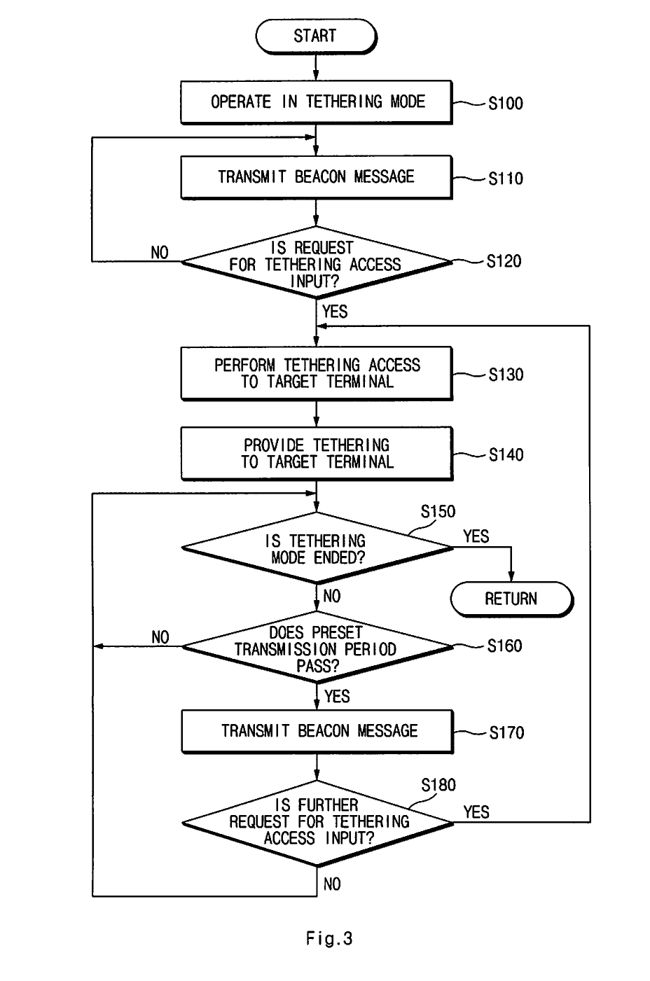

FIG. 3 is a flowchart illustrating a method of providing tethering in a tethering device according to an embodiment of the present invention.

Referring to FIG. 3, if the tethering device operates in the tethering mode in operation S100, the tethering device may transmit a beacon message for a tethering access to a target terminal in operation S110. If a tethering access request is not input from the target terminal in response to the transmitted beacon message in operation S120, the tethering device proceeds back to operation S110. If a tethering access request is input from the target terminal in response to the transmitted beacon message in operation S120, the tethering device performs the tethering access to the target terminal in operation S130. The tethering device provides, to the target terminal, tethering related to a communication channel formed between the tethering device and a communication network in operation S140.

In operation S150, the tethering device determines whether the tethering mode is ended. If the tethering mode is ended in operation S150, the tethering device may end a tethering mode according to a command to end the tethering mode. For example, the tethering device may end the tethering mode when a tethering mode end button is manipulated by a user or tethering accesses to all tethering-accessed target terminals are released. If there is a command to initiate the tethering mode after the end of the tethering mode, the tethering device may re-perform operation S100.

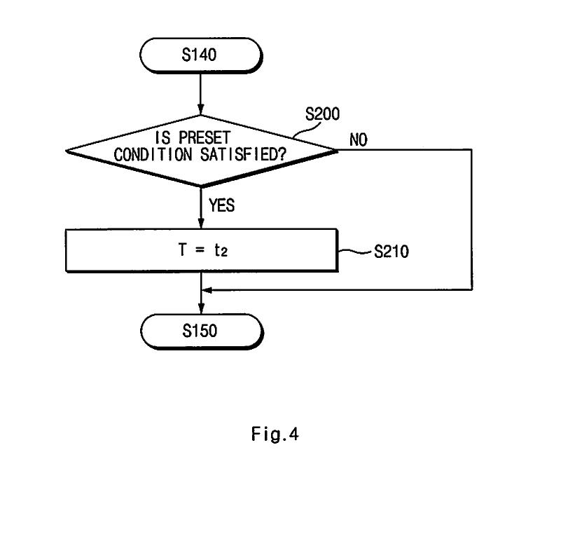

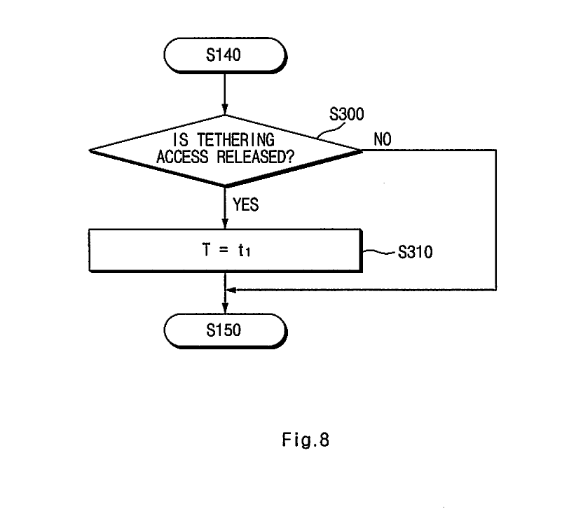

If the tethering mode is not ended in operation S150, the tethering device determines whether a preset transmission period T of the beacon message transmitted in operation S110 passes in operation S160. The tethering device proceeds back to operation S150 if the preset transmission period T does not pass. The tethering device transmits the beacon message in operation S170 if the preset transmission period T passes. In this example, the transmission period T may be set to a first period t1 or a second period t2 by the operations of FIGS. 4 and 8 to be described below. Thus, according to the values of the transmission period T, the tethering device may set the transmission period to t1 and transmit the beacon message or set the transmission period to t2 and transmit the beacon message.

In this case, the tethering access to the target terminal previously tethering-accessed by the beacon message transmitted in operation S170 may be maintained. Also, another target terminal may request the tethering access by the beacon message transmitted in operation S170. If a further tethering access request is input from another target terminal in operation S180, the tethering device performs a tethering access to the other target terminal in operation S130.

If there is no further tethering access request from another target terminal in operation S180, operations S150 to S170 may be repetitively performed.

FIG. 4 is a flowchart illustrating a method of adjusting the transmission period of a beacon message in a tethering device according to an embodiment of the present invention.

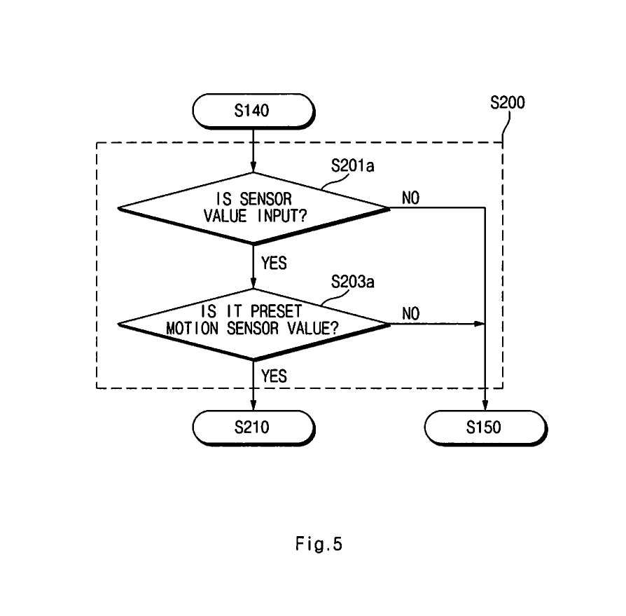

Referring to FIG. 4, while tethering is provided to a target terminal in operation S140, the tethering device determines whether a preset condition, namely, a specific condition preset to adjust the transmission period of the beacon message is satisfied in operation S200. Examples of an operation of determining whether the specific condition is satisfied in operation S200 are described in detail with reference to FIGS. 5 to 7.

Here, it is assumed that the transmission period T of the beacon message is initially set to a first period t1. If the specific condition is satisfied in operation S200, the tethering device adjusts the transmission period T of the beacon message to a second period t2 in operation S210. The second period t2 may be set to be longer than the first period t1 that is initially set. Thus, as the transmission period T of the beacon message is adjusted to the second period t2, it is possible to reduce power consumption due to the transmission of the beacon message while operating in the tethering mode, for example, through performing a power-saving function.

The tethering device maintains the transmission period T of the beacon message that is previously set if the specific condition is not satisfied in operation S200. In other words, when the specific condition is not satisfied while the transmission period T is set to the first period t1 that is an initial setting, the tethering device maintains the transmission period T as the first period t1. When operation S200 is performed after the transmission period T is already adjusted to the second period t2, the tethering device maintains the transmission period T as the second period if the preset specific condition is not satisfied. Then, the tethering device performs operation S150 which is same as that of FIG. 3.

Although not shown in FIG. 4, if a specific condition is satisfied in operation S200, the tethering device may also perform a power-saving function while performing operation S210 in order to decrease power consumption.

FIG. 5 represents a condition determining operation when an operation condition for adjusting the transmission period of a beacon message is set. In this example, FIG. 5 represents an operation of determining whether a value generated by user's manual manipulation satisfies a specific condition.

Referring to FIG. 5, in order to determine whether a specific condition is satisfied in operation S200, if a sensor value is input from at least one operation sensing sensor in the tethering device in operation S201a, the tethering device determines whether the sensor value input is an operation sensor value for a movement to a preset specific direction in operation S201a. If the input sensor value is the operation sensor value for the movement to the preset specific direction in operation S203a, the tethering device performs operation S210.

If the sensor value is not input in operation S201a or the input sensor value is not the operation sensor value for the movement to the preset specific direction in operation S203a, the tethering device performs operation S150.

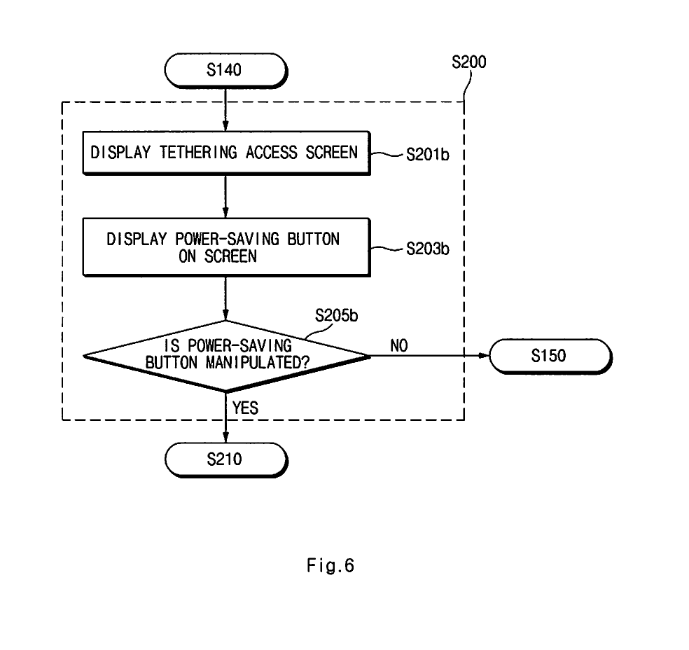

FIG. 6 represents a condition determining operation when a button manipulation condition for adjusting the transmission period of a beacon message is set. In this example, FIG. 6 represents an operation of determining whether a value generated by user's manual manipulation satisfies a specific condition.

Referring to FIG. 6, the tethering device displays a tethering access screen in operation S201b. The tethering device also displays a power-saving button on the tethering access screen in operation S203b when the tethering access screen is displayed in operation S201b. The tethering device determines whether the power-saving button displayed on the tethering access screen is manipulated by a user in operation S205b in order to determine whether a preset specific condition is satisfied in operation S200.

If it is verified that the power-saving button is selected by the user in operation S205b, the tethering device performs operation S210. The tethering device may provide a menu corresponding to a beacon message period to a screen corresponding to a tethering access. The tethering device may perform operation S210 based on an input corresponding to the menu corresponding to the beacon message period.

If the power-saving button is not manipulated by the user in operation S205b, the tethering device performs operation S150.

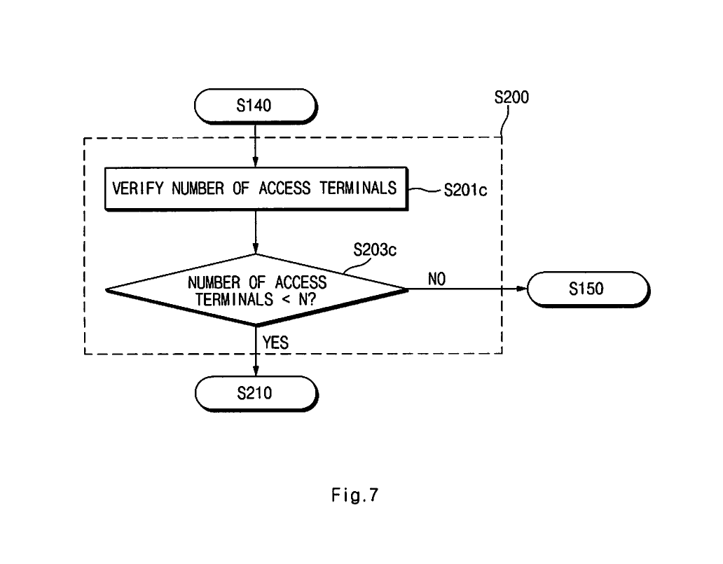

FIG. 7 represents a condition determining operation when a critical value for the number of tethering access terminals is set in order to adjust the transmission period of a beacon message, and represents, in particular, an operation of automatically determining whether a specific condition is satisfied.

Referring to FIG. 7, the tethering device verifies the number of target terminals tethering-accessed to the current tethering device in operation S201c. The tethering device compares the number of terminals verified in operation S201c with a critical value N in operation S203c in order to determine whether a preset specific condition is satisfied in operation S200, and determines whether the specific condition is satisfied by using the result.

When the number of the target terminals accessed to the tethering device is equal to or larger than the critical value N in operation S203c, the tethering device performs operation S210.

When the number of the target terminals accessed to the tethering device is smaller than the critical value N in operation S203c, the tethering device performs operation S150.

FIG. 8 is a flowchart illustrating a method of initializing the transmission period of a beacon message in a tethering device according to an embodiment of the present invention. In this example, the operations of FIG. 8 are performed while tethering is provided to tethering-accessed target terminals when performing the tethering function.

Referring to FIG. 8, while tethering is provided to target terminals in operation S140, the tethering device senses whether a tethering access is released in operation S300. When a tethering access to at least one target terminal is released in operation S300 while tethering is provided to target terminals, the tethering device initializes the transmission period T of a beacon message to a first period t1 in operation S310. When the transmission period T of the beacon is already set to the first period t1 before performing operation S310, operation S310 is skipped. Then, the tethering device performs operation S150 which is same as that of FIG. 3. When a tethering access to at least one target terminal is not released in operation S300 while tethering is provided to target terminals, the tethering device performs operation S150.

Although not shown in FIG. 8, the tethering device may also perform operation S310 after a power-saving function is completed. For example, the transmission period is set to a second period t2 by performing the power-saving function before performing operation S310.

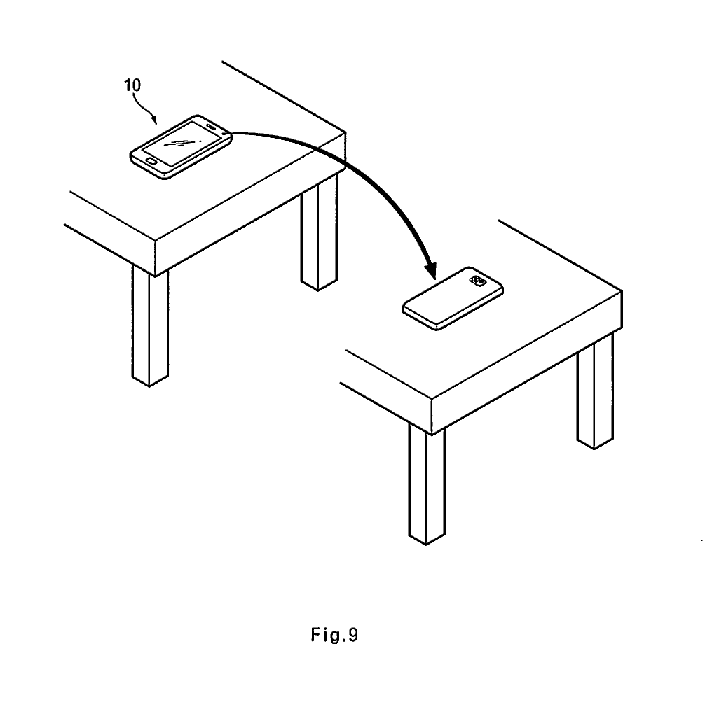

FIG. 9 is illustrated for explaining an operation of recognizing a specific operation in a tethering device according to an embodiment of the present invention.

When a user device providing tethering is operating in a tethering mode, a user may not verify (look at) a screen of a tethering device that is a user device providing tethering.

When the tethering device providing tethering to target terminals is reversed, that is, the rear surface of the tethering device is oriented upwards while providing tethering to target terminals as shown in FIG. 9, a sensor of the tethering device adjusts the transmission period of a beacon message by sensing an operation of reversing the tethering device or by sensing whether an object comes close to the front surfaces of the target terminals. the tethering device may minimize power consumption due to the frequent transmission of a beacon message by lengthening the time interval of the transmission period of a beacon message to be transmitted in order to maintain a tethering access while providing tethering to the target terminals.

In this example, the sensor may be a geomagnetic sensor that senses the rotating operation of the tethering device, or a proximity sensor that is arranged on the front surface of the tethering device.

Although FIG. 9 shows an example to adjust the transmission period of a beacon message by using an operation of reversing the tethering device, the present invention is not limited thereto.

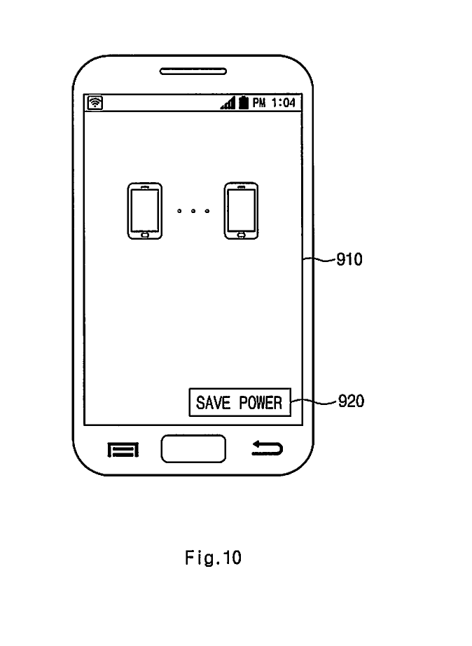

FIG. 10 illustrates recognition of a button manipulation in a tethering device according to an embodiment of the present invention.

Referring to FIG. 10, the tethering device displays a tethering access screen 910 when providing tethering to target terminals while being accessed to the target terminals wirelessly (for example, by using Wi-Fi). In this case, the tethering device displays a soft key type menu 920 on a tethering access screen 910 to enable a user to select the transmission period adjustment of a beacon message.

In this case, if the user manipulates the soft key type menu 920 displayed on the tethering access screen 910, the tethering device senses the manipulation of a corresponding menu 920 to enable the transmission period of a beacon message to be adjusted. Thus, the tethering device may minimize power consumption due to the frequent transmission of a beacon message by lengthening the time interval of the transmission period of a beacon message to be transmitted in order to maintain a tethering access while providing tethering to target terminals.

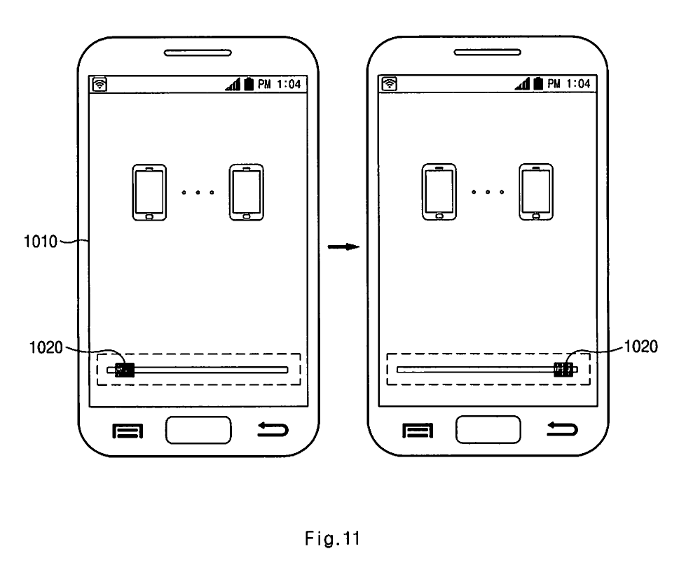

FIG. 11 illustrates recognition of a button manipulation in a tethering device according to another embodiment of the present invention.

Referring to FIG. 11, the tethering device displays a tethering access screen 1010 on which a scroll bar 1020 is implemented when providing tethering to target terminals while being Wi-Fi accessed to the target terminals. In this example, the scroll bar is implemented instead of a power-saving button and in types other than a soft key.

In this case, the user may scroll the scroll bar 1020 implemented on the tethering access screen 1010 from the left side to the right side, and the tethering device may sense the manipulation of the scroll bar 1020 implemented on the tethering access screen 1010 to enable the transmission period of a beacon message to be adjusted. Thus, the tethering device may minimize power consumption due to the frequent transmission of a beacon message by lengthening the time interval of the transmission period of a beacon message to be transmitted in order to maintain a tethering access while providing tethering to target terminals.

According to a tethering method and device that are proposed in various embodiments of the present invention, it is possible to variably apply the transmission period of a beacon message manually or automatically while providing tethering from a user device for providing tethering.

According to a tethering method and device that are proposed in various embodiments of the present invention, it is possible to minimize power consumption while providing tethering from a user device for providing tethering.

The block diagrams disclosed herein may be construed by a person skilled in the art as conceptual forms of circuits for implementing the principles of the present invention. Similarly, it will be appreciated by a person skilled in the art that any flow charts, state transition diagrams, and pseudo codes represent various processes that may be actually expressed on a computer-readable medium and executed by a computer or a processor whether or not the computer or the processor is explicitly shown. Thus, the above-described embodiments of the present invention can be written as computer programs and can be implemented in general-purpose digital computers that execute the programs using a computer-readable recording medium. Examples of the computer-readable recording medium include magnetic storage media (e.g., Read Only Memory (ROM), floppy disks, hard disks, etc.) and optical recording media (e.g., Compact Disk-ROM (CD-ROMs) or Digital Video Disk (DVDs)).

The functions of various elements shown in the Figures may be provided through hardware capable of executing software in association with proper software and through dedicated hardware. When being provided by a processor, such functions may be provided by a single dedicated processor, a single shared processor, or a plurality of individual processors of which some may be shared.

All the embodiments and conditional examples disclosed herein are described to help a person skilled in the art to understand the principle and concept of the present invention. It will be understood by a person skilled in the art that various changes in form and details may be made therein without departing from the spirit and scope of the present invention. The disclosed embodiments should be considered in a descriptive sense only and not for purposes of limitation. Therefore, the scope of the invention is defined not by the detailed description of the invention but by the appended claims and their equivalents, and all differences therebetween will be construed as being included in the present invention.

What is claimed is:

1. A device for tethering comprising:
a storage unit configured to store commands for a tethering operation; and
a control unit configured to perform the commands stored in the storage unit, to determine whether a preset condition is satisfied while providing tethering to at least one target terminal, and to adjust a transmission period of a beacon message transmitted at a certain period for the tethering when the preset condition is satisfied.

2. The device according to claim 1, wherein the control unit is further configured to increase the transmission period when the preset condition is satisfied.

3. The device according to claim 1, wherein the control unit is further configured to adjust the transmission period of the beacon message to decrease power consumption of the device when the preset condition is satisfied.

4. The device according to claim 1, wherein the control unit is further configured to initialize the transmission period of the beacon message when an access to the at least one target terminal for providing the tethering is released.

5. The device according to claim 1, wherein the preset condition is satisfied when a movement to a specific direction of the tethering device is recognized, when a user input associated with a specific button of the tethering device is recognized, or when a number of the at least one target terminal is greater than or equal to a specific value.

6. The device according to claim 1, further comprising a sensor unit configured to be operatively coupled to the device and to sense a movement of the tethering device in a specific direction, wherein the control unit is configured to determine whether the preset condition is satisfied, based on at least the movement sensed from a sensor value input through the sensor unit.

7. The device according to claim 1, further comprising a display unit configured to display a tethering access screen, wherein the tethering access screen is used to inform a user of a tethering access state while providing the tethering to the at least one target terminal, and to receive an input associated with the tethering from the user.

8. The device according to claim 7, wherein at least a portion of the tethering access screen includes a power-saving button for generating the preset condition in response to the input.

9. The device according to claim 8, wherein the control unit is configured to determine whether the preset condition is satisfied, based on whether the power-saving button is manipulated.

10. The device according to claim 8, wherein the power-saving button is implemented as a soft key type button.

11. The device according to claim 8, wherein the power-saving button is implemented as a scroll bar type button.

12. The device according to claim 1, wherein the control unit is configured to determine whether the preset condition is satisfied, based on a number of the at least one target terminal.

13. The device according to claim 1, wherein the control unit is configured to determine whether the preset condition is satisfied, based on a number of terminals in a pre-registered white list among the at least one target terminal.

14. A method for tethering in a device, the method comprising:
determining whether a preset condition is satisfied while providing tethering to at least one target terminal; and
adjusting a transmission period of a beacon message transmitted at a certain period depending on whether the preset condition is satisfied.

15. The method according to claim 14, wherein adjusting the transmission period of the beacon message comprises increasing the transmission period.

16. The method according to claim 14, wherein adjusting the transmission period of the beacon message comprises adjusting the transmission period to decrease power consumption of the device when the preset condition is satisfied.

17. The method according to claim 14, further comprising initializing the transmission period of the beacon message when an access to the at least one target terminal for providing the tethering is released.

18. The method according to claim 14, wherein the preset condition is satisfied when a movement of the tethering device to a specific direction is recognized, when a user input associated with a specific button of the tethering device is recognized, or when a number of the at least one target terminal is greater than or equal to a specific value.

19. A system comprising:
at least one target terminal; and
a user device configured to be connected to the at least one target terminal by using a local area communication technique, and to provide tethering related to a communication channel formed with an external communication network to the at least one target terminal,
wherein the user device adjusts a transmission period of a beacon message transmitted for the tethering depending on whether a preset condition is satisfied while providing the tethering to the at least one target terminal.
